(19) United States
(12) Patent Application Publication
(10) Pub. No.: US 2026/0005237 A1
(43) Pub. Date: Jan. 1, 2026

(54) Cathode Active Material for Lithium Secondary Battery and Lithium Secondary Battery Including the Same

(71) Applicant: SK On Co., Ltd., Seoul (KR)

(72) Inventors: Byoung Beom LIM, Daejeon (KR); Sang Wook LEE, Daejeon (KR); Sang Han LEE, Daejeon (KR); Yong Hyun CHO, Daejeon (KR)

(21) Appl. No.: 19/248,615

(22) Filed: Jun. 25, 2025

(30) Foreign Application Priority Data
Jun. 26, 2024 (KR) 10-2024-0083707

(51) Int. Cl. H01M 4/525; C01G 53/506; H01M 4/36; H01M 4/38; H01M 10/052

(52) U.S. Cl. CPC H01M 4/525; C01G 53/506; H01M 4/366; H01M 4/38; H01M 10/052; C01P 2002/60; C01P 2002/74; C01P 2002/85; C01P 2006/40

(57) ABSTRACT

Embodiments of the present disclosure provide a cathode active material for a lithium secondary battery. The cathode active material for a lithium secondary battery includes lithium-transition metal oxide particles having a nickel oxidation number ratio of 0.24 to 0.98, as defined by Equation 1. By adjusting the nickel oxidation number ratio of the lithium-transition metal oxide particles, a lithium secondary battery with improved cycle life characteristics and capacity characteristics may be provided.

### CROSS-REFERENCE TO RELATED APPLICATIONS

This patent application claims the priority and benefits of Korean Patent Application No. 10-2024-0083707 filed on Jun. 26, 2024, the disclosure of which is incorporated herein by reference in its entirety.

### BACKGROUND

### 1. Field of the Invention

The embodiments of the present disclosure generally relates to a cathode active material for a lithium secondary battery and a lithium secondary battery including the same.

### 2. Description of the Related Art

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

In the lithium secondary battery, a lithium metal oxide is used as a cathode active material, and it is preferable to have a high capacity, a high output, and high cycle life characteristics. However, when designing the lithium metal oxide for a high output composition, thermal and mechanical stabilities may be deteriorated, and thereby cycle life characteristics and operational reliability of the lithium secondary battery may be deteriorated.

### SUMMARY

According to an aspect of the present disclosure, there may be provided a cathode active material for a lithium secondary battery with improved operating stability and cycle life characteristics.

According to an aspect of the present disclosure, there may be provided a lithium secondary battery with improved operating stability and cycle life characteristics.

A cathode active material for a lithium secondary battery according to exemplary embodiments of the present disclosure may include lithium-transition metal oxide particles having a nickel (Ni) oxidation number ratio of 0.24 to 0.98, as defined by Equation 1 below.

$$[ Equation 1 ]$$

$$Nickel ( Ni ) oxidation number ratio = m ( {Ni}^{2 +} ) / ( m ( {Ni}^{2 +} ) + m ( {Ni}^{3 +} ) )$$

In Equation 1, m(Ni²⁺) may be the molar amount of Ni²⁺ in the lithium-transition metal oxide particles, as measured by X-ray photoelectron spectroscopy (XPS) analysis, and m(Ni³⁺) may be the molar amount of Ni³⁺ in the lithium-transition metal oxide particles, as measured by XPS analysis.

In some embodiments, the lithium-transition metal oxide particles may have an A value of 3.0 to 7.0, as defined by Equation 2 below.

$$A = ( XRD peak intensity ratio / Crystal grain size ) \times 100 \qquad [ Equation 2 ]$$

In Equation 2, the XRD peak intensity ratio (%) may be defined by Equation 3 below, and the crystal grain size (nm) may be the crystal grain size of the lithium-transition metal oxide particles measured by X-ray diffraction (XRD) analysis.

$$[ Equation 3 ]$$

$$XRD peak intensity ratio ( \% ) = 100 \times I ( 110 ) / \{ I ( 110 ) + I ( 003 ) \}$$

In Equation 3, I(110) may be the maximum height of a peak of a (110) plane of the lithium-transition metal oxide particles, as measured by XRD analysis, and I(003) may be the maximum height of a peak of a (003) plane of the lithium-transition metal oxide particles, as measured by XRD analysis.

In some embodiments, the crystal grain size may be calculated by Equation 4 below.

$$L = \frac{0.9 λ}{β cos θ} \qquad [ Equation 4 ]$$

In Equation 4, L may be the crystal grain size (nm) of the lithium-transition metal oxide particles, λ may be the X-ray wavelength (nm), β may be the fullwidth at half maximum (rad) of the peak of the (003) plane of the lithium-transition metal oxide particles, and θ may be the diffraction angle (rad).

In some embodiments, the XRD peak intensity ratio of the lithium-transition metal oxide particles may be 3% or more.

In some embodiments, the XRD peak intensity ratio of the lithium-transition metal oxide particles may be 3% to 15%.

In some embodiments, the crystal grain size of the lithium-transition metal oxide particles may be 100 nm or more.

In some embodiments, the crystal grain size of the lithium-transition metal oxide particles may be 100 nm to 300 nm.

In some embodiments, the lithium-transition metal oxide particles may be represented by Formula 1 below:

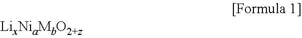

In Formula 1, 0.9≤x≤1.2, 0.5≤a≤0.99, 0.01≤b≤0.5 and −0.5≤z≤0.1, and M may include at least one selected from the group consisting of Co, Mn and Al.

In some embodiments, a in Formula 1 may be in the range of 0.8≤a≤0.99.

In some embodiments, the lithium-transition metal oxide particles may include a doping element or a coating element, and the doping element or the coating element may include at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr.

In some embodiments, the doping element or the coating element may include at least one selected from the group consisting of Zr, Nb, Hf, V, Ta, Mo, W, B, Ti and Sn.

In some embodiments, the doping element or the coating element may include at least one selected from the group consisting of Zr, Nb, V, Mo and Ti.

A lithium secondary battery according to exemplary embodiments of the present disclosure may include: a cathode comprising the above-described cathode active material for a lithium secondary battery; and an anode disposed opposite to the cathode.

According to an embodiment of the present disclosure, the cycle life characteristics of the cathode active material and/or the secondary battery may be enhanced.

According to an embodiment of the present disclosure, cracks or damage to the cathode active material may be prevented. By controlling the size of crystal grains, it is possible to prevent deterioration in output characteristics due to an excessive increase in the migration distance of lithium ions intercalated into and deintercalated from the cathode active material during charging and discharging of the secondary battery.

According to an embodiment of the present disclosure, the amount of gas generation may be reduced and the cycle life characteristics may be improved. The cathode active material for a lithium secondary battery and the lithium secondary battery including the same of the present disclosure may be widely applied in green technology fields, such as electric vehicles, battery charging stations, as well as solar power generation, wind power generation, and the like, which use the batteries. The cathode active material for a lithium secondary battery and the lithium secondary battery including the same of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are schematic plan and cross-sectional views illustrating a lithium secondary battery according to exemplary embodiments, respectively.

### DETAILED DESCRIPTION

Embodiments of the present disclosure provide a cathode active material for a lithium secondary battery (hereinafter, also abbreviated as a cathode active material). In addition, a lithium secondary battery (hereinafter, also abbreviated as a secondary battery) including the cathode active material for a lithium secondary battery is provided.

Hereinafter, embodiments of the present disclosure will be described in detail with reference to the accompanying drawings. However, these are merely illustrative and the present disclosure is not limited to the specific embodiments described by way of example.

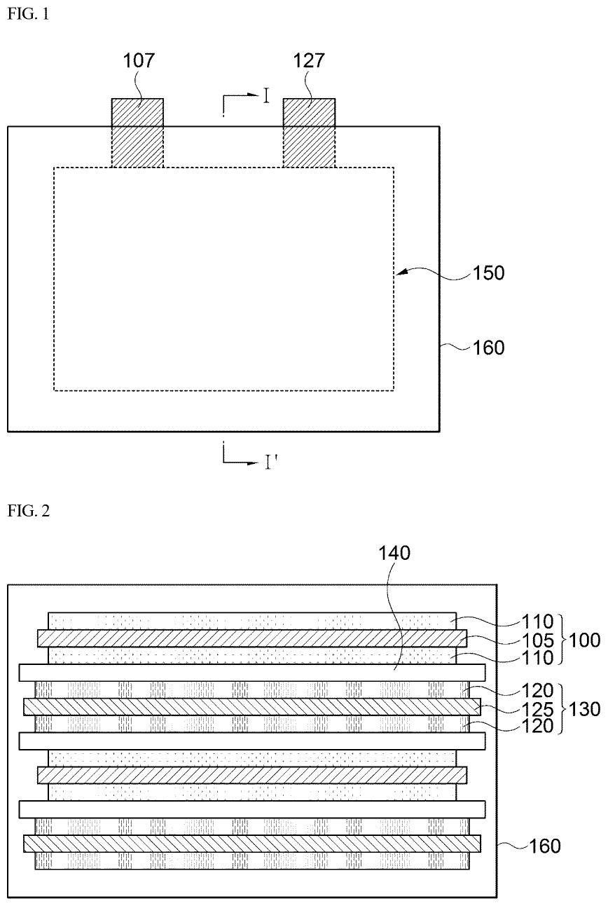

FIGS. 1 and 2 are schematic plan and cross-sectional views illustrating a lithium secondary battery according to exemplary embodiments, respectively. For example, FIG. 2 is a cross-sectional view taken along line I-I′ in FIG. 1.

Referring to FIGS. 1 and 2, the lithium secondary battery may include a cathode 100 and an anode 130 disposed opposite to the cathode 100.

The cathode 100 may include a cathode active material layer 110 formed by applying a cathode active material to at least one surface of a cathode current collector 105.

The cathode current collector 105 may include stainless steel, nickel, aluminum, titanium, copper, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

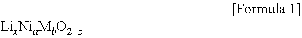

In Formula 1, x, a, band z may satisfy 0.9≤x≤1.2, 0.5≤a≤099, 0.01≤b≤0.5, −0.5≤z≤0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of the additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form a bond, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element which contributes to the capacity/output activity of the cathode active material together with Co or Mn like Al.

For example, the cathode active material or the lithium-nickel metal oxide may include a layered structure or a crystal structure represented by Formula 1-1 below.

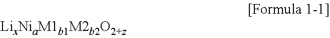

In Formula 1-1, M1 may include Co, Mn and/or Al. M2 may include the auxiliary elements described above. In Formula 1-1, x, a, b1, b2 and z may satisfy 0.9≤x≤1.2, 0.5≤a≤0.99, 0.01≤b1+b2≤0.5, −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

In some embodiments, the doping element or the coating element may include at least one selected from the group consisting of Zr, Nb, Hf, V, Ta, Mo, W, B, Ti and Sn. Accordingly, the shape and structure of the lithium-transition metal oxide particles may be further stabilized.

In some embodiments, the doping element or the coating element may include at least one selected from the group consisting of Zr, Nb, V, Mo and Ti. Accordingly, the shape and structure of the lithium-transition metal oxide particles may be further stabilized while improving surface stability.

The coating element or doping element may exist on the surface of the lithium-nickel metal oxide particles, or may penetrate through the surface of the lithium-nickel metal composite oxide particles to become incorporated into the bonding structure represented by Formula 1 or Formula 1-1.

The cathode active material may include a nickel-cobalt-manganese (NCM)-based lithium oxide. In this case, an NCM-based lithium oxide with an increased content of nickel may be used.

Nickel may be provided as a transition metal associated with the output and capacity of the lithium secondary battery. Therefore, as described above, by employing a high-nickel-content (high-Ni) composition in the cathode active material, ahigh-capacity cathode and ahigh-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

The content of Ni (e.g., a molar fraction of nickel based on the total number of moles of nickel, cobalt and manganese) may be 0.5 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

The cathode active material may be mixed in a solvent to prepare a cathode slurry. The cathode slurry may be applied to at least one surface of the cathode current collector 105, then dried and pressed to prepare the cathode active material layer 110. The coating may include a method such as gravure coating slot die coating simultaneous multilayer die coating imprinting doctor blade coating dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black Ketjen black graphene, carbon nanotubes, vapor-grown carbon fibers (VGCFs), carbon fibers, and/or metal-based conductive materials, including perovskite materials, such as tin, tin oxide, titanium oxide, LaSrCoO₃, and LaSrMnO₃. These may be used alone or in combination of two or more thereof.

The cathode slurry may further include a thickener and/or dispersant. In one embodiment, the cathode slurry may include a thickener such as carboxymethyl cellulose (CMC).

The cathode active material may include a plurality of the lithium-transition metal oxide particles. For example, the total content of the lithium-transition metal oxide particles based on the total weight of the cathode active material may be 50% by weight (“wt %”) or more. In some embodiments, the total content of the lithium-transition metal oxide particles based on the total weight of the cathode active material may be 60 wt % or more, 70 wt % or more, 80 wt % or more, or 90 wt % or more.

In one embodiment, the cathode active material may be substantially composed of the lithium-transition metal oxide particles.

In exemplary embodiments, the nickel included in the cathode active material may include Ni³⁺ having an oxidation number of 3 and/or Ni²⁺ having an oxidation number of 2.

X-ray photoelectron spectroscopy (XPS) analysis may be performed on the cathode active material. Through XPS analysis, the content of nickel in the lithium-transition metal oxide particles, such as the molar amount of Ni³⁺ and Ni²⁺, may be measured.

In exemplary embodiments, the cathode active material may include lithium-transition metal oxide particles having a nickel (Ni) oxidation number ratio of 0.24 to 0.98, as defined by Equation 1 below.

$$[ Equation 1 ]$$

$$Nickel ( Ni ) oxidation number ratio = m ( {Ni}^{2 +} ) / ( m ( {Ni}^{2 +} ) + m ( {Ni}^{3 +} ) )$$

In Equation 1 above, m(Ni²⁺) and m(Ni³⁺) may be the molar amounts of Ni²⁺ and Ni³⁺ in the lithium-transition metal oxide particles, respectively, as measured by X-ray photoelectron spectroscopy (XPS) analysis.

If the nickel oxidation number ratio is less than 0.24, the molar amount of Ni²⁺ may be relatively too small compared to Ni³⁺, which may reduce the probability of substitution between Ni ions (Ni²⁺) and lithium ions (Li⁺). Since the probability of Ni²⁺ (ionic radius: 0.69 Å), which has a similar ionic radius to lithium ions (ionic radius: 0.72 Å), occupying the site where lithium ions are released decreases, the stability of the cathode active material may be reduced during charge and discharge cycles. Therefore, the cycle life characteristics of the secondary battery may deteriorate, and its high-temperature stability may decrease.

When the nickel oxidation number ratio exceeds 0.98, the molar amount of Ni²⁺ is too large, which may limit the migration distance of lithium ions, and thus charging and discharging of the secondary battery may not be performed smoothly. Accordingly, the output characteristics of the secondary battery may deteriorate, and the internal resistance of the electrode may increase, which may be disadvantageous in terms of mechanical and electrical stability.

The molar amount of Ni²⁺ and the molar amount of Ni³⁺ may be controlled within a desired range by introducing a substitution material, changing the heat treatment temperature conditions, or adjusting the composition ratio among Ni, Co and Mn.

The substitution material may include at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr.

In some embodiments, the crystal grain size of the lithium-transition metal oxide particles may be calculated by applying the Scherrer equation of Equation 4 below to the full width at half maximum (FWHM) obtained through XRD analysis.

$$L = \frac{0.9 λ}{β cos θ} \qquad [ Equation 4 ]$$

In Equation 4 above, L represents the crystal grain size (nm), λ represents the X-ray wavelength (nm), θ represents the diffraction angle (rad), and β represents the full width at half maximum (rad) of the peak corresponding to the diffraction angle (θ). According to exemplary embodiments, the FWHM for measuring the crystal grain size in the XRD analysis may be obtained from the peak of the (003) plane of the lithium-transition metal oxide particles.

In some embodiments, β in Equation 4 above may use a full width at half maximum corrected for instrument-derived broadening. In one embodiment, Si may be used as a standard material to reflect the instrument-derived contribution. In this case, by fitting the FWHM profile across the full 2θ range of Si, the instrument-derived FWHM may be expressed as a function of 2θ. Thereafter, a corrected value obtained by subtracting the instrument-derived FWHM at the corresponding 2θ from the measured FWHM may be used as β.

In exemplary embodiments, the crystal grain size may be 100 nm or more, and in some embodiments, may range 100 nm to 300 nm. Within the above range, high-power and high-capacity characteristics through the High-Ni composition may be sufficiently achieved, while thermal stability and cycle life characteristics may be maintained or improved.

For example, the lithium-transition metal oxide particles may be prepared by wet- or dry-mixing a nickel-manganese-cobalt precursor (e.g., nickel-cobalt-manganese hydroxide) with a lithium precursor (e.g., lithium hydroxide or lithium carbonate), reacting the mixture, and then calcining the resulting reactant.

In one embodiment, the crystal grain size of the lithium-transition metal oxide particles may be controlled by adjusting the calcination temperature or by introducing a substitution material.

The substitution material may represent an element that substitutes for some of the transition metal elements at the same site in the nickel-manganese-cobalt layered crystal structure.

The substitution material may include at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr.

The lithium-transition metal oxide particles may have a single-crystalline and/or polycrystalline structure in terms of crystallography. In one embodiment, the cathode active material may include a mixture or blend of single-crystalline particles and polycrystalline particles having the above-described crystal grain size.

The lithium-transition metal oxide particles may have a morphology of single particles, primary particles, or secondary particles.

According to exemplary embodiments, the lithium-transition metal oxide particles may have an XRD peak intensity ratio of 3% or more, as defined by Equation 3 below.

$$[ Equation 3 ]$$

$$XRD peak intensity ratio ( \% ) = 100 \times I ( 110 ) / \{ I ( 110 ) + I ( 003 ) \}$$

In Equation 3 above, I(110) and I(003) may represent the maximum heights of the peaks of the (110) plane and (003) plane, respectively, of the lithium-transition metal oxide particles, as measured by X-ray diffraction (XRD) analysis.

For example, the XRD analysis may be performed on dried powder of the lithium-transition metal oxide particles using Cu Kα rays as a light source, within a diffraction angle (20) range of 10° to 120°, at a scan rate of 0.0065°/step.

High-Ni lithium-transition metal oxide particles may, for example, exhibit a cation mixing phenomenon in which lithium ions (Li⁺) and nickel ions (Ni²⁺) in the lithium layer are irreversibly substituted at high temperatures, thereby causing degradation of the battery. This cation mixing phenomenon propagates from the surface of the (110) plane to the interior, and when the diffusion length of lithium ions increases, the substitution between lithium ions and nickel ions may be reduced, thereby alleviating structural degradation caused by cation mixing. However, if the migration distance of lithium ions increases excessively, the output characteristics of the secondary battery may deteriorate.

Within the above-described XRD peak intensity ratio range, the ion propagation length and diffusion length in the (110) plane through which lithium ions diffuse may be maintained within an appropriate range. As a result, cation mixing may be reduced, thereby decreasing the degradation area of the lithium-transition metal oxide particles. Accordingly, the cycle life characteristics at high temperatures and during charging and discharging may be improved, and the amount of gas generation may be reduced.

In addition, for example, relative degradation in cycle life characteristics due to the adjustment of the crystal grain size may be alleviated or supplemented by adjusting the XRD peak intensity ratio.

In some embodiments, the XRD peak intensity ratio of the lithium-transition metal oxide particles may be 3% to 15%. Within this range, while maintaining the surface stability and cycle life characteristics of the lithium-transition metal oxide particles, a deterioration in output characteristics due to an excessively long migration path of lithium ions may be prevented.

In exemplary embodiments, the lithium-transition metal oxide particles may have an A value of 3.0 to 7.0, as defined by Equation 2 below.

$$A = ( XRD peak intensity ratio / Crystal grain size ) \times 100 \qquad [ Equation 2 ]$$

In Equation 2 above, the XRD peak intensity ratio may be defined by Equation 3 above, and the crystal grain size may refer to the crystal grain size of the lithium-transition metal oxide particles.

Within the above A value range, the crystal grain size and XRD peak intensity ratio may be appropriately adjusted. Specifically, the A value may represent a degree to which the crystal grain size and XRD peak intensity ratio increase or decrease. Accordingly, by adjusting the crystal gain size within the above range, the lithium ion migration characteristics may be enhanced, thereby increasing the output and capacity, and by adjusting the XRD peak intensity ratio, cation mixing may be prevented, thereby improving cycle life stability. In addition, the value of the XRD peak intensity ratio may be adjusted to prevent the migration distance of lithium ions from becoming excessively long.

For example, a transition metal precursor (e.g., a Ni—Co—Mn precursor) for preparing the lithium-transition metal oxide particles may be prepared by a co-precipitation reaction.

The above-described transition metal precursor may be prepared by a co-precipitation reaction of metal salts. The metal salts may include nickel salts, manganese salts and cobalt salts.

Examples of the nickel salt may include nickel sulfate, nickel hydroxide, nickel nitrate, nickel acetate, and a hydrate thereof, etc. Examples of the manganese salt may include manganese sulfate, manganese acetate, and a hydrate thereof, etc. Examples of the cobalt salt may include cobalt sulfate, cobalt nitrate, cobalt carbonate, and a hydrate thereof, etc.

The metal salts may be mixed with a precipitant and/or a chelating agent in a ratio that satisfies the content of each metal or the concentration ratios described with reference to Formula 1 or Formula 1-1 to prepare an aqueous solution. The aqueous solution may be subjected to co-precipitation in a reactor to prepare the transition metal precursor.

The precipitant may include an alkaline compound such as sodium hydroxide (NaOH), sodium carbonate (Na₂CO₃) and the like. The chelating agent may include, for example, ammonium hydroxide (e.g., NH₃H₂O), ammonium carbonate (e.g., NH₃HCO₃) and the like.

The temperature of the co-precipitation reaction may be controlled, for example, in the range of about 40° C. to 60° C. The reaction time may be adjusted in the range of about 24 hours to 72 hours.

For example, a transition metal precursor may be reacted with a lithium precursor to prepare lithium-transition metal oxide particles. The lithium precursor compound may include, for example, lithium carbonate, lithium nitrate, lithium acetate, lithium oxide, lithium hydroxide, etc. These may be used alone or in combination of two or more thereof.

Thereafter, for example, lithium impurities or unreacted precursors may be removed through a washing process, and metal particles may be fixed or crystallinity may be improved through a heat treatment (calcination) process. In one embodiment, the heat treatment temperature may be in the range of about 600° C. to 1000° C.

For example, the above-described crystal grain size and XRD peak intensity ratio may vary depending on the co-precipitation reaction time, reaction temperature, heat treatment temperature, etc.

The anode 130 may include an anode current collector 125 and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more. For example, the anode current collector 125 may have a thickness of 10 μm to 50 μm.

The anode active material layer 120 may include the anode active material including the above-described composite particles 50. For example, the anode active material may include a plurality of composite particles 50.

In some embodiments, the anode active material may include the composite particles 50 and a graphite-based active material. For example, the graphite-based active material may include artificial graphite and/or natural graphite.

The content of the composite particles 50 may be 3 wt % or more, 5 wt % or more, 10 wt % or more, 15 wt % or more, 20 wt % or more, 25 wt % or more, 30 wt % or more, 35 wt % or more, 40 wt % or more, or 45 wt % or more based on the total weight of the anode active material (e.g., the total weight of the plurality of composite particles 50 and the graphite-based active material).

The content of the composite particles may be 99 wt % or less, 95 wt % or less, 90 wt % or less, 85 wt % or less, 80 wt % or less, 75 wt % or less, 70 wt % or less, 65 wt % or less, 60 wt % or less, 55 wt % or less, or 50 wt % or less based on the total weight of the anode active material.

In one embodiment, the anode active material may be substantially composed of the composite particles 50 and the graphite-based active material.

The anode active material may be mixed in a solvent to prepare an anode slurry. The anode slurry may be applied/deposited to the anode current collector 125, then dried and pressed to prepare an anode active material layer 120. The coating may include a method such as gravure coating slot die coating simultaneous multilayer die coating imprinting doctor blade coating dip coating bar coating or casting. The anode active material layer 120 may further include a binder, and optionally further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may be used for the anode.

In some embodiments, a styrene-butadiene rubber (SBR)-based binder, carboxymethyl cellulose (CMC), polyacrylic acid-based binder, poly(3,4-ethylenedioxythiophene (PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow a flow of ions to occur. For example, the separation membrane may have a thickness of 10 to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be applied to the polymer film or dispersed within the polymer film to improve heat resistance.

The separation membrane 140 may have a single-layer or multi-layer structure including the above-described polymer film and/or non-woven fabric.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding stacking, z-folding, or stack-folding the separation membrane 140.

The electrode assembly 150 may be accommodated in a case 160 together with an electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)N⁻, CF₃CF₃)₂CO⁻, (CF₃SO₂)₂CH⁻, (SFO)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, and propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted cyclic carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato) phosphate, lithium difluoro phosphate, etc.

The borate compound may include lithium bis(oxalate)borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 1 and 2, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### EXAMPLES

### (1) Preparation and Analysis of Lithium-Transition Metal Oxide Particles

### 1) First to Eighth Particles and Tenth to Sixteenth Particles

NiSO₄, CoSO₄ and MnSO₄ were mixed in a molar ratio of 0.8:0.1:0.1 using distilled water from which dissolved oxygen had been removed by bubbling N₂ through it for 24 hours. The solution was introduced into a reactor at 50° C., and NaOH as a precipitant and NH₃H₂O as a chelating agent were added thereto, followed by performing a co-precipitation reaction for 72 hours to obtain Ni_{0.8}Co_{0.1}Mn_{0.1}(OH)₂ as a transition metal precursor. The obtained precursor was dried at 100° C. for 12 hours, and then further dried at 120° C. for 10 hours.

Lithium hydroxide and the transition metal precursor were added to a dry high-speed mixer in a ratio of 1.03:1 and uniformly mixed for 20 minutes. The mixture was placed in a calcination furnace, heated to 750° C. at a heating rate of 2° C./min, and maintained at 750° C. for 12 hours. Oxygen was continuously supplied at a flow rate of 10 mL/min during the heating and holding steps. After completion of the calcination, the mixture was naturally cooled to room temperature, then pulverized and classified to prepare lithium-transition metal oxide particles (first particles) having a composition of LiNi_{0.8}Co_{0.1}Mn_{0.1}O₂ as a cathode active material.

The reaction time and temperature in the reactor, and the calcination time, calcination temperature, and heating rate in the calcination process were varied, and the composition ratio of Ni, Co and Mn, as well as the presence and content of the substitution material, were adjusted to additionally prepare the second to eighth particles and the tenth to sixteenth particles.

The substitution material was at least one of Ti, Zr, Al, Mg, Ta, V, Nb, B, and W, and the content of the substitution material based on the total number of moles of metals included in the lithium-transition metal oxide particles was adjusted to 0 mol % to 0.05 mol %.

For each of the lithium-transition metal oxide particles, the nickel oxidation number ratio was calculated using the above-described Equation 1, the XRD peak intensity ratio was calculated using Equation 3, and the crystal grain size was measured using Equation 4, through XPS analysis and XRD analysis.

Meanwhile, the XPS analysis was performed using the Quantum 2000 manufactured by Physical Electronics Inc. (acceleration voltage: 0.5 to 15 keV, 300 W, energy resolution: about 1.0 eV, minimum analysis area: 10 μm, sputter rate: 0.1 nm/min).

In addition, the equipment and conditions for the XRD analysis are shown in Table 1 below.

TABLE 1
XRD (X-Ray Diffractometer) EMPYREAN

| Maker | PANalytical | |
|---|---|---|
| Anode material | Cu | |
| K-Alpha1 wavelength | 1.540598 | Å |
| Generator voltage | 45 | kV |
| Tube current | 40 | mA |

| | |
|---|---|
| Scan Range | 10-120° |
| Scan Step Size | 0.0065° |
| Divergence slit | ¼° |
| Anti-scatter slit | ½° |

### 2) Ninth Particles

The ninth particles were prepared in the same manner as the first particles, except that Mg(OH)₂ was additionally added to the mixture of lithium hydroxide and the transition metal precursor so that the magnesium content was 200 ppm based on the total weight of the lithium-transition metal oxide particles.

### (2) Example 1

A secondary battery was manufactured using the above-described first particles as a cathode active material. Specifically, the cathode active material, Denka Black as a conductive material, and PVDF as a binder were mixed in a mass ratio of 97:2:1 to prepare a cathode slurry. Then, the slurry was applied to an aluminum current collector, then dried and pressed to prepare a cathode. After the pressing, an electrode density of the cathode was controlled in a range of 3.55 g/cc or more.

An anode slurry, which included 93 wt % of natural graphite as an anode active material, 5 wt % of KS6 as a flake type conductive material, 1 wt % of styrene-butadiene rubber (SBR) as a binder, and 1 wt % of carboxymethyl cellulose (CMC) as a thickener, was prepared. The anode slurry was applied to a copper substrate, then dried and pressed to prepare an anode.

The cathode and the anode prepared as described above were respectively notched into a predetermined size and stacked, then an electrode cell was fabricated by interposing a separator (polyethylene, thickness: 25 μm) between the cathode and the anode. Thereafter, tab parts of the cathode and the anode were welded, respectively. The assembly of the welded cathode/separator/anode was placed into a pouch, and three sides of the pouch were sealed, leaving one side open for electrolyte injection. At this time, a portion having the electrode tab was included in the sealing part. After injecting the electrolyte through the remaining open side except for the sealing part, the remaining open side was also sealed, followed by allowing the cell to be impregnated for 12 hours or more.

A solution, prepared by dissolving 1M LiPF₆ solution in a mixed solvent of EC/EMC/DEC (25/45/30; volume ratio) and further adding 1 wt % of vinylene carbonate (VC), 0.5 wt % of 1,3-propene sultone (PRS), and 0.5 wt % of lithium bis(oxalato)borate (LiBOB), was used as the electrolyte.

Then, pre-charging was conducted on the secondary battery manufactured as described above with a current (5 A) corresponding to 0.25C for 36 minutes. After 1 hour, degassing was performed, then aging for 24 hours or more was conducted, followed by performing formation charging-discharging (charging conditions: CC-CV 0.2C 4.2V 0.05C CUT-OFF; discharging conditions: CC 0.2C 2.5V CUT-OFF). Thereafter, a lithium secondary battery according to Example 1 was obtained.

### (3) Example 2

A secondary battery was manufactured in the same manner as in Example 1, except that the above-described second particles were used as the cathode active material.

### (4) Example 3

A secondary battery was manufactured in the same manner as in Example 1, except that the above-described third particles were used as the cathode active material.

### (5) Example 4

A secondary battery was manufactured in the same manner as in Example 1, except that the above-described fourth particles were used as the cathode active material.

### (6) Example 5

A secondary battery was manufactured in the same manner as in Example 1, except that the above-described fifth particles were used as the cathode active material.

### (7) Example 6

A secondary battery was manufactured in the same manner as in Example 1, except that the above-described sixth particles were used as the cathode active material.

### (8) Example 7

A secondary battery was manufactured in the same manner as in Example 1, except that the above-described seventh particles were used as the cathode active material.

### (9) Example 8

A secondary battery was manufactured in the same manner as in Example 1, except that the above-described eighth particles were used as the cathode active material.

### (10) Example 9

A secondary battery was manufactured in the same manner as in Example 1, except that the above-described ninth particles were used as the cathode active material.

### (11) Comparative Example 1

A secondary battery was manufactured in the same manner as in Example 1, except that the above-described tenth particles were used as the cathode active material.

### (12) Comparative Example 2

A secondary battery was manufactured in the same manner as in Example 1, except that the above-described eleventh particles were used as the cathode active material.

### (13) Comparative Example 3

A secondary battery was manufactured in the same manner as in Example 1, except that the above-described twelfth particles were used as the cathode active material.

### (14) Comparative Example 4

A secondary battery was manufactured in the same manner as in Example 1, except that the above-described thirteenth particles were used as the cathode active material.

### (15) Comparative Example 5

A secondary battery was manufactured in the same manner as in Example 1, except that the above-described fourteenth particles were used as the cathode active material.

### (16) Comparative Example 6

A secondary battery was manufactured in the same manner as in Example 1, except that the above-described fifteenth particles were used as the cathode active material.

### (17) Comparative Example 7

A secondary battery was manufactured in the same manner as in Example 1, except that the above-described sixteenth particles were used as the cathode active material.

The XPS analysis values, XRD analysis values, and calculation values according to Equations 1 and 2 for the lithium-transition metal oxide particles (the first to the sixteenth particles) of the above-described examples and comparative examples are shown in Table 2.

TABLE 2

| | Nickel | XRD peak | Crystal | |
|---|---|---|---|---|
| | oxidation | intensity | grain | |
| | number | ratio | size | |
| Classification | ratio | (%) | (nm) | A |
| First particle | 0.98 | 6.92 | 186 | 3.72 |
| Second particle | 0.24 | 8.62 | 224 | 3.85 |
| Third particle | 0.54 | 9.73 | 168 | 5.79 |
| Fourth particle | 0.52 | 4.55 | 179 | 2.54 |
| Fifth particle | 0.47 | 3.7 | 92 | 4.02 |
| Sixth particle | 0.39 | 12.45 | 320 | 3.89 |
| Seventh particle | 0.58 | 2.93 | 102 | 2.87 |
| Eighth particle | 0.68 | 19.78 | 298 | 6.64 |
| Ninth particle | 0.66 | 14.94 | 233 | 6.41 |
| Tenth particle | 0.99 | 5.58 | 210 | 2.66 |
| Eleventh particle | 0.21 | 15.48 | 154 | 10.05 |
| Twelfth particle | 0.07 | 17.82 | 202 | 8.82 |
| Thirteenth particle | 1.76 | 19.57 | 715 | 2.74 |
| Fourteenth particle | 0.08 | 2.11 | 676 | 0.31 |
| Fifteenth particle | 1.3 | 2.72 | 194 | 1.40 |
| Sixteenth particle | 1.55 | 14.02 | 590 | 2.38 |

### Experimental Example

### (1) Measurement of Cycle Life Characteristics (Capacity Retention Rate) at 45° C.

After 500 cycles of repeated charging (CC-CV 1.0C 4.2V 0.05C CUT-OFF) and discharging (CC 1.0 C 2.7V CUT-OFF) were performed on the lithium secondary batteries prepared according to the above-described examples and comparative examples, the discharge capacity at the 500th cycle was determined by calculating the discharge capacity at the 500th cycle as a percentage (%) of the discharge capacity at the 1st cycle.

### (2) Measurement of Room Temperature DCIR

The lithium secondary batteries of the above-described examples and comparative examples were subjected to two charge/discharge cycles at 25° C. and under 0.5C CC-CV conditions (state-of-charge (SOC) 100%). Subsequently, the batteries were charged again under 0.5C CC-CV conditions, and discharged at 0.5C until the SOC reached 50%. Thereafter, the voltage (first voltage) was measured after resting for 30 minutes.

Next, the batteries were subjected to i) a 1C discharge for 10 seconds followed by 40-second rest, ii) a 0.75C charge for 10 seconds followed by another 40-second rest. The voltage (second voltage) was then measured. The DCIR was calculated using the difference between the first voltage and the second voltage.

The evaluation results are shown in Table 3 below.

TABLE 3

| | Lithium-transition | Capacity | |
|---|---|---|---|
| | metal oxide | retention rate | DCIR |
| Classification | particles | at 45° C. (%) | (mΩ) |
| Example 1 | First particle | 88 | 3.23 |
| Example 2 | Second particle | 82 | 3.15 |
| Example 3 | Third particle | 92 | 3.38 |
| Example 4 | Fourth particle | 84 | 3.28 |
| Example 5 | Fifth particle | 82 | 3.92 |
| Example 6 | Sixth particle | 84 | 3.83 |
| Example 7 | Seventh particle | 89 | 3.87 |
| Example 8 | Eighth particle | 83 | 3.29 |
| Example 9 | Ninth particle | 93 | 3.62 |
| Comparative | Tenth particle | 79 | 4.82 |
| Example 1 | | | |
| Comparative | Eleventh particle | 62 | 4.97 |
| Example 2 | | | |
| Comparative | Twelfth particle | 75 | 4.81 |
| Example 3 | | | |
| Comparative | Thirteenth particle | 73 | 4.65 |
| Example 4 | | | |
| Comparative | Fourteenth particle | 62 | 4.89 |
| Example 5 | | | |
| Comparative | Fifteenth particle | 76 | 4.55 |
| Example 6 | | | |
| Comparative | Sixteenth particle | 63 | 4.13 |
| Example 7 | | | |

Referring to Tables 2 and 3, in Examples 1 to 9, where the nickel oxidation number ratio was 0.24 to 0.98, the capacity retention rate characteristics and low-resistance characteristics were improved compared to the comparative examples.

In Example 4, where A was less than 3, the resistance was relatively increased and the capacity retention rate was reduced compared to the other examples.

In Example 5, where the crystal grain size was less than 100 nm, the capacity retention rate was relatively reduced and the resistance was increased compared to the other examples.

In Example 6, where the crystal grain size was more than 300 nm, the capacity retention rate was relatively reduced and the resistance was increased compared to the other examples.

In Example 7, where the XRD peak intensity ratio was less than 3%, the resistance was relatively increased compared to the other examples.

In Example 8, where the XRD peak intensity ratio was greater than 15%, the capacity retention rate was relatively reduced compared to the other examples.

In Example 9, where Mg was used as the doping element, the capacity retention rate was relatively increased compared to Examples 1 and 2, where no doping element was used.

1. A cathode active material for a lithium secondary battery, comprising lithium-transition metal oxide particles having a nickel (Ni) oxidation number ratio of 0.24 to 0.98, as defined by Equation 1 below:
$$[ Equation 1 ]$$
$$Nickel ( Ni ) oxidation number ratio = m ( {Ni}^{2 +} ) / ( m ( {Ni}^{2 +} ) + m ( {Ni}^{3 +} ) )$$
(in Equation 1, m(Ni²⁺) is the molar amount of Ni²⁺ in the lithium-transition metal oxide particles, as measured by X-ray photoelectron spectroscopy (XPS) analysis, and m(Ni³⁺) is the molar amount of Ni³⁺ in the lithium-transition metal oxide particles, as measured by XPS analysis).

2. The cathode active material for a lithium secondary battery according to claim 1, wherein the lithium-transition metal oxide particles have an A value of 3.0 to 7.0, as defined by Equation 2 below:
$$A = ( XRD peak intensity ratio / Crystal grain size ) \times 100 \qquad [ Equation 2 ]$$
(in Equation 2, the XRD peak intensity ratio (%) is defined by Equation 3 below, and the crystal grain size (nm) is the crystal grain size of the lithium-transition metal oxide particles measured by X-ray diffraction (XRD) analysis)
$$[ Equation 3 ]$$
$$XRD peak intensity ratio ( \% ) = 100 \times I ( 110 ) / \{ I ( 110 ) + I ( 003 ) \}$$
(in Equation 3, I(110) is the maximum height of a peak of a (110) plane of the lithium-transition metal oxide particles, as measured by XRD analysis, and I(003) is the maximum height of a peak of a (003) plane of the lithium-transition metal oxide particles, as measured by XRD analysis).

3. The cathode active material for a lithium secondary battery according to claim 2, wherein the crystal grain size is calculated by Equation 4 below:
$$L = \frac{0.9 λ}{β cos θ} \qquad [ Equation 4 ]$$
(in Equation 4, L is the crystal grain size (nm) of the lithium-transition metal oxide particles, λ is the X-ray wavelength (nm), β is the full width at half maximum (rad) of the peak of the (003) plane of the lithium-transition metal oxide particles, and θ is the diffraction angle (rad)).

4. The cathode active material for a lithium secondary battery according to claim 2, wherein the XRD peak intensity ratio of the lithium-transition metal oxide particles is 3% or more.

5. The cathode active material for a lithium secondary battery according to claim 4, wherein the XRD peak intensity ratio of the lithium-transition metal oxide particles is 3% to 15%.

6. The cathode active material for a lithium secondary battery according to claim 2, wherein the crystal grin size of the lithium-transition metal oxide particles is 100 nm or mor.

7. The cathode active material for a lithium secondary battery according to claim 5, wherein the crystal grin size of the lithium-transition metal oxide particles is 100 nm to 300 nm.

8. The cathode active material for a lithium secondary battery according to claim 1, wherein the lithium-transition metal oxide particles are represented by Formula 1 below: 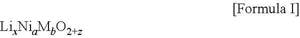
(in Formula 1, 0.9≤x≤1.2, 0.5≤a≤0.99, 0.01≤b≤0.5 and −0.5≤z≤0.1, and M includes at least one selected from the group consisting of Co, Mn and Al).

9. The cathode active material for a lithium secondary battery according to claim 8, wherein a in Formula 1 is in the range of 0.8≤a≤0.99.

10. The cathode active material for a lithium secondary battery according to claim 1, wherein the lithium-transition metal oxide particles comprise a doping element or a coating element, and
the doping element or the coating element comprises at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr.

11. The cathode active material for a lithium secondary battery according to claim 10, wherein the doping element or the coating element comprises at least one selected from the group consisting of Zr, Nb, Hf, V, Ta, Mo, W, B, Ti and Sₙ.

12. The cathode active material for a lithium secondary battery according to claim 10, wherein the doping element or the coating element comprises at least one selected from the group consisting of Zr, Nb, V, Mo and Ti.

13. A lithium secondary battery comprising:
a cathode comprising the cathode active material for a lithium secondary battery according to claim 1; and
an anode disposed opposite to the cathode.
